(19) United States
(12) Patent Application Publication
(10) Pub. No.: US 2008/0210077 A1
(43) Pub. Date: Sep. 4, 2008

(54) Combination bass with both frets and no frets on the same neck

(76) Inventor: Franklin Dale Boxberger, Scottsdale, AZ (US)

Correspondence Address: Franklin Dale Boxberger Jr., 10703 East Pinnacle Peak Road, Scottadlae, AZ, 85255, US

(21) Appl. No.: 11/712,935

(22) Filed: Mar. 2, 2007

(51) Int. Cl. G10D 1/08

(52) U.S. Cl. 84/263

(57) ABSTRACT

A musical instrument comprising of a fretted bass guitar and a fretless bass guitar as a single instrument and with only one neck. This multi stringed instrument has anywhere between four and twelve strings and combines some areas of the neck with frets and some areas with no frets. The pick-up system is also divided as to split as an output a stereo signal. This stereo signal or dual output in turn allows the two different basses (fretted and fretless) to be controlled separately or independently with respect to volume, equalization and signal processing.

This invention concerns a new musical instrument which comprises the features of a common fretted bass guitar and a common fretless bass guitar each having more than one string and being combined on a single neck. This bass guitar could be either electric or acoustic.

It is already well known that at present the fretted bass guitar and the fretless bass guitar form two different instruments, which must be, according to the different sounds desired, alternated by the player, and this brings along evident functional limitations. It is, therefore, the aim of the present invention to combine in a single instrument on a single neck a combination of two different types of bass guitars on a single neck which can be played alternately and simultaneously and still produce the same true tones which: would be obtained if the fretted and fretless basses were being played as separate instruments.

The aim set forth is reached realizing a musical instrument provided with a single neck having frets for some of the strings while some of the strings have no frets. The frets of the conventional bass guitar are spaced at normal intervals, while the other portion of the neck has no frets. The fretted portion could be located on either the top portion of the neck or the bottom portion of the neck. The fretless portion would then be on the opposite side. This single necked bass guitar instrument could have anywhere from four to twelve strings in total.

The amount of fretted stings and fretless strings does not need to be proportionate, meaning that an odd number of strings could be utilized. For instance three fretted stings and four fretless strings.

A further feature of the instrument is, consequently, the presence of a bridge which may be longer than the one found on a common bass guitar, as it must receive anywhere from four to twelve strings. For the same reason, the tailpiece will be longer than the common one, as it must receive the same four to twelve strings.

According to the present invention, the pick-ups (if electric) of the fretted bass will be placed on the body of the instrument, said pick-up being being placed in the area directly under the fitted bass strings 8, and the second in the area of the fretless bass guitar strings 25; each one of said pick-ups is connected, through a single, common outlet, provided in the instrument, to an amplifier consisting, as already known, in two inlet channels (stereo) and two amplifiers and loud speakers. It should be understood that two separate outlets could be used, if desired. Also each set of strings (fretted and fretless) could have one, two or even three pickups each mounted on or in the body of this bass guitar for each said amplifier system.

The objects of the present invention will be now shown, more in detail, relating to the enclosed drawing, showing a front view of the instrument.

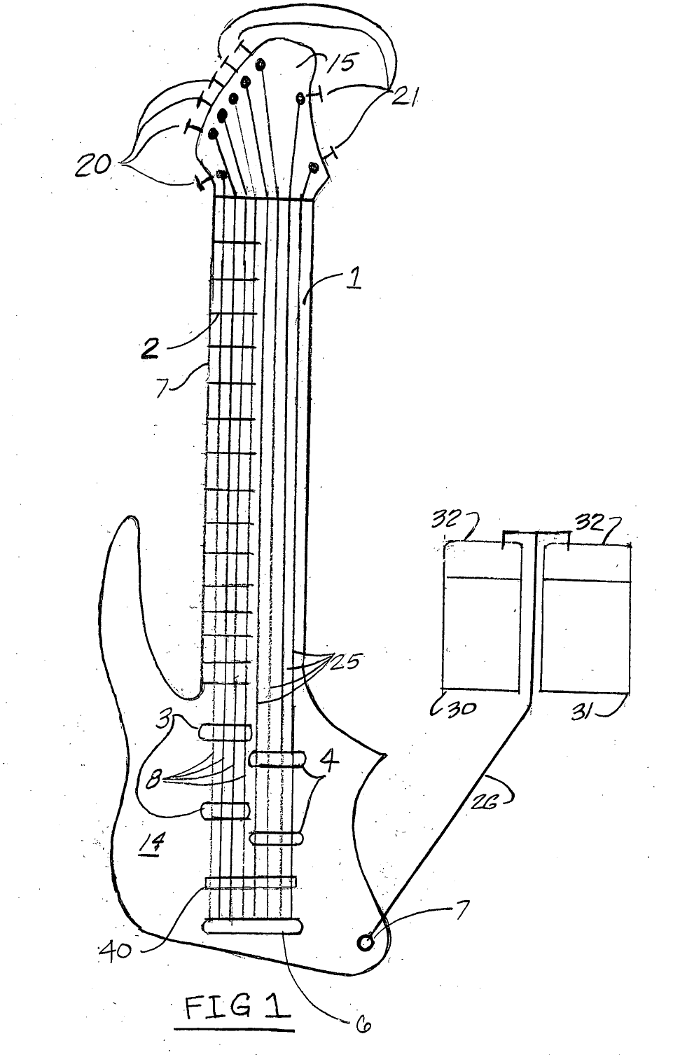

FIG. 1 is a plan view of my combination fretted bass guitar and fretless bass guitar connected through a common stereo outlet to a pair of amplifiers and a pair of speakers.

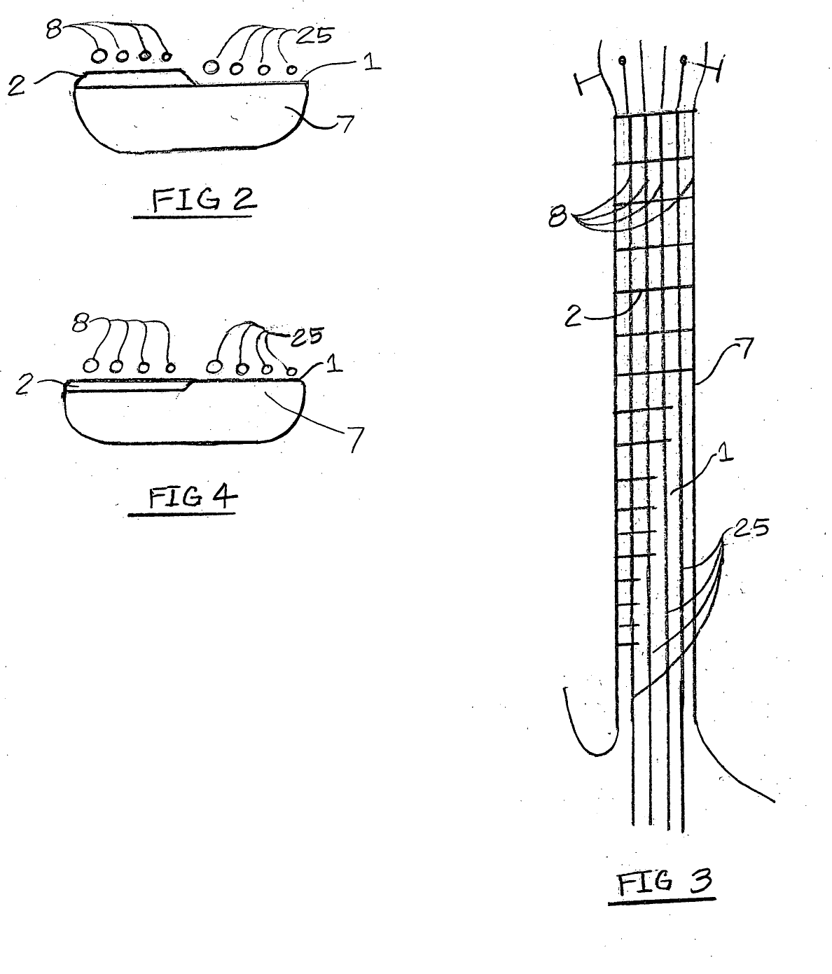

FIG. 2 is a partial view showing an optional raised neck on the fretless side so that all of the strings will be lined up evenly at the side of the string closest (facing the neck) to the fret and neck for ease for fretted and fretless play respectively.

A neck 1 is provided, may be larger in width than the ones known in the conventional bass guitars. See FIG. 1. This is attached to the body 14, which has mounted thereon an adjustable bridge 5 and a tailpiece 6, thus allowing the disposition, spacing and adjustment of the strings of the fretted bass guitar and the strings of the fretless bass guitar and, at the same time, still allow an easy handling of the instrument.

The numeral 2 shows one of the common frets of the neck, these frets would end or terminate at the location between the strings that was desired to change from the fretted portion of the bass to the fretless portion of the bass. Again the fretless portion of the bass could be reversed and the fretted and fretless portion on the neck could be reversed. A first pick-up 3 for the bass and a second pickup 4 for the guitar lead to a common outlet 7, while electric strings 8 of the fretted bass, together with strings 25 of the fretless bass, are placed on bridge 40 and fixed to a tailpiece 6.

Again this neck could be either level. See FIG. 2. Or the neck could be raised for even play. This dual-level, raised neck would be raised on the fretless side to meet the frets evenly. See FIG. 4. The fretted and fretless portion of the neck could even be divided on the same string. SEE FIG. 3. The advantage of the raised neck on the fretless portion is to allow all of the strings to be the same distance to the playing surface, whether it is a fret or no fret. This dual-level raised neck (FIG. 4) allows a player to have the same action and ease of playing on both of the fretted and fretless portion of the neck 7.

Of course, it is evident from FIG. 1, that the first pick-up and the second pick-up are placed underneath the fretted bass 8 and fretless bass strings 25 respectively at a predetermined position on the body portion 14 of the bass guitar. To the common stereo outlet 7, connected by suitable electrical wiring designated by the numeral 26, are a bass amplifier 30 and a second bass amplifier 31. Connected one each to the bass amplifiers are loud speakers 32, thus, completing the equipment necessary to properly amplify and reproduce the sounds and individual effects and equalization of each different bass guitars independently of my improved musical instrument.

It is evident that the structure of neck 1 responds to the need for easy handling to allow the two instruments to be played at the same time, still keeping the distinction between the fretted bass and the fretless bass.

Also, the left hand, which embraces neck 1, is in condition to play all the strings at the same time, or either the fretted bass or the fretless bass separately or alternately, according to the music played and the effects and equalization desired. This allows the instrument to be played in rapid succession as desired as a fretted bass and a fretless bass, as while the left hand is performing its conventional function, the right hand, by use of the thumb, index fingers or pick; can be used to play any of the bass strings, thus the instrument will be played as a fretted or fretless bass for the entire time. Of course, the instrument comprising my invention and these functions can be reversed if the player is a left-handed player, rather than the normal right-handed player. Both the right hand and the left hand could be used on the neck to play with a tapping style. This tapping style could then allow a player to play a fretted bass and a fretless bass at virtually the same time. This is because each set of fingers on each hand is hitting the different set of strings (fretted and fretless) at the same time.

The present invention has been described according to a preferred embodiment thereof. It is understood that modifications can be applied to the form, disposition and dimensions thereof without exceeding the scope of the present invention.

I claim:

1. A musical instrument combining a fretted bass guitar having typical bass guitar strings and a fretless bass guitar having typical fretless flat wound bass strings into a single instrument with a single neck.

2. This invention defined in claim 1, provides the following advantage to the player: it allows one player to play both types of bass guitars, fretted and fretless, without switching bass guitars.

3. This multi-stringed instrument defined in claim 1, has only one neck and will accommodate from four to twelve strings.

4. The fretted and fretless portion can be split with any combination of: two to ten stings for the fretted portion of the neck and two to ten strings for the fretless portion of the neck. This allows a very versatile instrument.

5. The single neck as defined in claim 1, can be constructed with the neck of the fretless portion raised to the height of the adjacent fret. See FIG. 4. This allows a balance in action between the fretted and fretless portion of this bass guitar.

6. A stereo output of this instrument as defined in claim 1, allows two different amplification systems along with two different sets of effects and equalization for each of the two different combined basses fretted and fretless.

7. The player of this instrument as defined in claim 1, can use the fretted portion of the neck as a visual reference as a guide for positioning and intonation of the fretless portion of the neck.

8. The player of this instrument as defined in claim 1, can play both basses one at a time, simultaneously, cross over and play together, and can actually use both hands on the neck as a tapping instrument.

9. The device defined in claim 6, and including a dual bass amplifier system connected to said fretted bass string pick-up and a fretless bass string pick-up through said stereo outlet.

10. The two bass guitars on one neck as defined in claim 1, allow alternate tunings, combinations of a variety of the number of strings for each of the fretted and fretless basses combined on this instrument.

11. This multi-stringed instrument as defined in claim 1, has only one neck and will accommodate from four to twelve strings. This will allow this instrument to be very versatile for all styles of play.
